(19) United States
(12) Patent Application Publication
(10) Pub. No.: US 2011/0262739 A1
(43) Pub. Date: Oct. 27, 2011

(54) PROCESS FOR PRODUCTION OF TRANSFER-EXCELLENT IN THE RESISTANCE TO BURR GENERATION AND TRANSFER SHEETS

(75) Inventors: Tomoya Watase, Kyoto (JP); Masayuki Kyomen, Kyoto (JP); Masahiro Nishida, Kyoto (JP)

(73) Assignee: NISSHA PRNTING CO., LTD., Kyoto-shi (JP)

(21) Appl. No.: 12/734,923

(22) PCT Filed: Dec. 8, 2008
(86) PCT No.: PCT/JP2008/003637

§ 371 Date: Jul. 22, 2010

(30) Foreign Application Priority Data
Dec. 10, 2007 (JP) 2007-317801

(51) Int. Cl. B32B 3/00; C08L 39/00; B41M 3/12

(52) U.S. Cl. 428/331; 427/146; 524/555

(57) ABSTRACT

A process for the production of a transfer sheet provided with a protective layer which is more excellent in the resistance to burr generation and in wear resistance and which is also excellent in the ability to follow the curved surface of a substrate; and a transfer sheet (1) comprising a releasable support sheet (11) and a transfer layer (20) formed on the support sheet (11), wherein the transfer layer (20) has a protective layer (21). The protective layer (21) is formed by heating a protective layer precursor (which is in an uncrosslinked state) made of a material prepared by mixing an actinic-radiation-curable resin composition comprising both a polymer (A) having a (meth)acrylic equivalent of 100 to 300 g/eq, a hydroxyl value of 20 to 500, and a weight-average molecular weight of 5000 to 50000 and a polyfunctional isocyanate with colloidal silica particles bearing free silanol groups on the surfaces and contains a product of heat crosslinking among the polymer (A), the polyfunctional isocyanate, and the colloidal silica particles.

### TECHNICAL FIELD

The present invention relates to a transfer sheet used for transferring a transfer layer to a transferred material such as plastic products and metal products for decoration. More specifically, this invention relates to a transfer sheet which serves to prevent burr from being generated so that a transfer layer outside a transfer area may not remain on the surface of the transferred material when a support film is released and which has the transfer area excellent in wear resistance. The transfer area means an area of the transfer layer formed on the transfer sheet, which area should be transferred to the transferred material.

### BACKGROUND ART

Transfer sheets have been used to decorate the surface of many kinds of products such as resin molded articles, interior materials, fittings, furniture, and sundries.

In general, a transfer layer formed on the support film of the transfer sheet has a protective layer (in some cases, referred to as “release layer”), a picture layer, an adhesive layer, and other layers. It is not practical to completely conform the area of the transfer layer to that of the transferred surface of the transferred material, mainly because of difficulty in making register. For this reason, the area of the transfer layer of the transfer sheet is arranged to be larger than that of the transferred surface of the transferred material. Therefore, the transfer layer has two areas: a transfer area touching the transferred surface and a non-transfer area not touching the transferred surface, both of which border on each other. The border between the two areas is a borderline (in some cases, referred to as “partition line”). After the transfer layer was attached to the transferred material, the support film is released. At that time, the transfer layer should be cut off neatly on the partition line and the transfer layer in the transfer area should be transferred to the transferred material, with the transfer layer of the non-transfer area being removed together with the support film. If the operation described above is completely performed, no problem is caused.

However, when the support film is released after the transfer layer was attached to the transferred material, the transfer layer in the non-transfer area near the said partition line, which is pulled toward the transfer layer in the transfer area, remains, like a tongue, on the surface of the transferred material. This is so-called “burr”.

FIG. 5 is an explanatory drawing showing the scene of the support sheet (11) being released after the transfer of the transfer layer (20) to the transferred material (31) by using the transfer sheet (101) available commonly. A broken line (142) is a partition line. The part shown with a line segment (141) is a burr caused as described above.

The burr must be removed by using a suction device or manually. It takes much time and effort to remove many burrs, which leads to increase of manufacturing costs for the transfer products and causes dirtying of transfer apparatus and molds at the time of the transfer processing or the formation and transfer processing at the same moment. Therefore, transfer sheets should have less burr (in some cases, referred to as “excellent in the resistance to burr generation”), which is fundamental performance required of the transfer sheet).

Another fundamental performance required of the transfer sheet is the protecting layer's excellence in wear resistance, which is important for increasing endurance of the transferred surface of the transferred material.

In some cases, the transfer sheet is referred to as “transfer foil”.

For some of transfer sheets used commonly, at least one layer near the support sheet out of the transfer layers placed on a releasable support sheet is a rigid membrane layer containing cubic inorganic particles in a resin binder, which are harder than the said resin binder, for improving resistance to burr generation and wear resistance (refer to a patent document 1 for instance).

Furthermore, for some of the other transfer sheets used commonly, at least one layer near the support sheet out of the layers placed on the releasable support sheet is a rigid membrane layer containing 10 to 90 weight % of metal oxide particles (average particle size: 0.01 to 15 μm), for improving resistance to burr generation and wear resistance (refer to a patent document 2 for instance).

Furthermore, for protecting layers of transfer sheets used commonly, an actinic-radiation-curable resin composition containing both a polymer with a (meta)acrylic equivalent of 100 to 300 g/eq, a hydroxyle value of 20 to 500, and a weight-average molecular weight of 5000 to 50000 and a polyfunctional isocyanate as active element is used. The use of the said composition makes it possible to produce molded articles having excellent wear resistance and chemical resistance at low cost (refer to a patent document 3 for instance).
Patent document 1: Japanese patent Laid-Open No. 2001-232994
Patent document 2: Japanese patent Laid-Open No. H05-139093
Patent document 3: Japanese patent Laid-Open No. 1110-58895

### SUMMARY OF THE INVENTION

### Subjects to be Solved by the Invention

For the transfer sheets described in the patent document 1 and the patent document 2, a rigid film layer for which resin and inorganic particles are mixed is used. The inorganic particles are only mixed with the resin, without receiving any chemical or physical processing. For this reason, the film layer is not so hard as to be expected, which does not lead to the dramatic improvement of the protecting layer's wear resistance. Furthermore, inorganic particles must be added at high concentrations to improve the protecting layer's resistance to burr generation.

One idea for further improvement of the wear resistance and resistance to burr generation of a rigid membrane layer described in the patent document 1 and the patent document 2 is to increase the mixture fraction of inorganic particles. However, this idea causes inferior transparence and decreased flexibility of the rigid film layer because of the large particle size of the inorganic particles and other reasons.

A protecting layer for which the resin composition described in the patent document 3 is used is a flexible layer for transfer processing, hence having a feature of preventing a crack to be generated on the curbed surface of the molded article. However, the protecting layer, which has a high viscosity under the conditions of transfer processing, tends to cause burr generation more often than other resin articles.

Therefore, it is an object of the present invention to provide a process for the production of a transfer sheet having a protecting layer which is more excellent in wear resistance and resistance to burr generation. It is another object of the present invention to provide a process for the production of a transfer sheet which can prevent a crack to be generated on the curbed surface of the transferred materials.

It is still another object of the present invention to provide a transfer sheet having a protecting layer which is more excellent in wear resistance and resistance to burr generation. It is still another object of the present invention to provide a transfer sheet which can prevent the curbed surface of the transferred materials form being cracked.

The other objects of the present invention will become apparent from the detailed description to follow.

### Methods to Solve the Subjects

A process for the production of the transfer sheet according an embodiment of the present invention comprises the following operations.

a) an operation of manufacturing a protecting layer material by mixing an actinic-radiation-curable resin composition comprising a polymer A having a (meta)acrylic equivalent of 100 to 300 g/eq, a hydroxyle value of 20 to 500, and a weight-average molecular weight of 5000 to 50000 and a polyfunctional isocyanate with colloidal silica particles bearing free silanol groups on their surface;
b) an operation of forming a protecting layer in an uncross-linked state on a separable support sheet by attaching the said protecting layer material thereto; and
c) an operation of forming a protecting layer by producing a product of heat cross-linking among the polymer A, the polyfunctional isocyanate, and the colloidal silica particles by heating the said protecting layer in an uncross-linked state.

In the present invention, (meta)acrylic equivalent means the sum of acrylic equivalent and methacryl equivalent.

In a preferred embodiment of the present invention, the primary particle size of the said colloidal silica particles may be 1 to 200 nm.

In another preferred embodiment of the present invention, the ratio by weight of the solid content of colloidal silica particle/polymer A of the said protecting layer may be 0.2 to 1.0.

The transfer sheet according to another embodiment of the present invention is a transfer sheet having a transfer layer arranged on a releasable support sheet, wherein the protecting layer included in the said transfer layer is a protecting layer containing a product of heat cross-linking among the polymer A, the polyfunctional isocyanate, and the colloidal silica particles formed by heating the protecting layer in an uncross-linked state made of a protecting layer material prepared by mixing an actinic-radiation-curable resin composition comprising a polymer A having a (meta)acrylic equivalent of 100 to 300 g/eq, a hydroxyle value of 20 to 500, and a weight-average molecular weight of 5000 to 50000 and a polyfunctional isocyanate with colloidal silica bearing free silanol groups on the surface.

In a preferred embodiment of the present invention, the primary particle size of the said colloidal silica particles may be 1 to 200 nm.

In another preferred embodiment of the present invention, the ratio by weight of the solid content of colloidal silica particle/polymer A of the said protecting layer may be 0.2 to 1.0.

The present invention, the preferred embodiments of the present invention, and the constituent elements included in them as described above may be embodied in other forms when they are combined to as much extent as possible.

### Effectiveness of the Invention

The process for the production of the transfer sheet according to the present invention is a method of providing a transfer sheet having a protecting layer containing a product of heat cross-linking among the polymer A, the polyfunctional isocyanate, and the colloidal silica particles together with other compositions. The transfer sheet according to the other embodiments of the present invention has a protecting layer containing a product of heat cross-linking among the polymer A, the polyfunctional isocyanate, and the colloidal silica particles together with other compositions.

In the heat cross-linking, free silanol groups of colloidal silica particles and hydroxyl groups of polymer A react with isocyanate to form a product of heat cross-linking (hereinafter referred to as “Si heat cross-linking product” in some cases). On the other hand, a product of heat cross-linking among conventional polymer A and polyfunctional isocyanate is referred to as “NonSi heat cross-linking product” in some cases.

The transfer and processing operation using the transfer sheet includes transfer operation and release operation. The transfer operation is a process in which the transfer layer in the transfer sheet is transferred to the transferred material and the release operation is a process in which the transfer sheet (support sheet) is released from the transferred material. The temperature range of the transfer operation (referred to as “transfer temperature range” in some cases) is higher than that of the release operation (referred to as “release temperature range” in some cases).

The glass-transition point of the Si heat cross-linking product moves to higher temperature side, compared with that of the NonSi heat cross-linking product. The Si heat cross-linking product becomes less viscous in the release temperature range, compared with the NonSi heat cross-linking product. In other words, a film composed of the Si heat cross-linking product becomes stretchy at high temperatures, which is an innate characteristic of the said resin, whereas it becomes brittle, like glass, at low temperatures.

That is to say, because the protecting layer in the transfer sheet according to the present invention becomes less viscous in the release temperature range, the transfer layer can be cut off neatly at the partition line. This improves the transfer sheet's resistance to burr generation.

Furthermore, the protecting layer of the transfer sheet according to the present invention has so high viscosity at the transfer temperature range that the transfer layer such as the protecting layer may follow the curved surface of the transferred material. This prevents cracks from being produced at the curbed surface of the transferred material.

The polymer A and the polyfunctional isocyanate, whic are an actinic-radiation-curable resin composition, comprise a protecting layer. When the protecting layer transferred to the transferred material is exposed to actinic radiation, unsaturated groups of ethylene moieties contained in the polymer A make cross-linking reaction through radical polymerization to form a cross-linking hardener. Then, hard silica particles are incorporated into the cross-linking hardener. This improves wear resistance of the protecting layer transferred to the transferred material.

### BRIEF DESCRIPTION OF THE DRAWINGS

FIG. 1 is a cross sectional view of the transfer sheet 1.

FIG. 2 is a cross sectional view of the mold and the like showing the point where the temperature was measured.

FIG. 3 is a graph showing the relationship between logarithmic attenuation coefficient (viscous value) and temperature.

FIG. 4 is an explanatory drawing showing the scene of the support sheet (11) being released after the transfer of the transfer layer (20) to the transferred material (31).

FIG. 5 is an explanatory drawing showing the scene of the support sheet (11) being released after the transfer of the transfer layer (20) to the transferred material (31) by using the transfer sheet (101) available commonly.

### DESCRIPTION OF THE REFERENCE NUMERAL

1 Transfer sheet
11 Support sheet
20 Transfer layer
21 Protecting layer
22 Picture layer
23 Adhesive layer
31 Transferred material
51 Mold A
52 Mold B
53 Injection nozzle
54 Molded article
55 Transfer consecutive sheet
61 Arrow showing break part
101 Transfer sheet available commonly
141 Line segment showing burr
142 Partition line

### MOST PREFERRED EMBODIMENT TO CARRY OUT THE INVENTION

Referring to the drawings, a process for the production of the transfer sheet and the transfer sheet according to the examples of the present invention will be described in more detail. Unless otherwise specifically stated, measurements, materials, shapes, relative positions and the like of the members and parts described in the examples of the present invention are merely examples for explanation and are not intended to restrict the scope of the present invention hereto. In particular, the vertical scale reduction and the horizontal scale reduction are not the same in the cross sectional view of the transfer sheet to clarify the layer constitution of the transfer sheet.

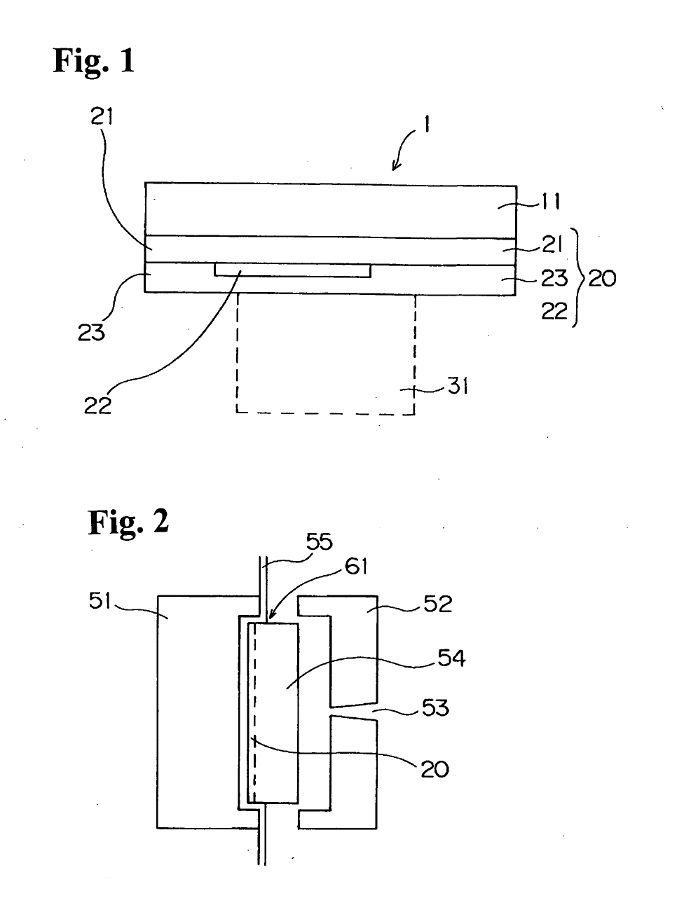

FIG. 1 is a cross sectional view of the transfer sheet of the present invention. For the transfer sheet (1), the protecting layer (21), the picture layer (22), and the adhesive layer (23) are formed on one side of the support sheet (11) in this order. In FIG. 1, the broken line shows the transferred material (31). The protecting layer (21), the picture layer (22), and the adhesive layer (23), which are layers to be transferred to the transferred material (31), are collectively referred to as “transfer layer (20)”.

When the support sheet (11) is released after the transfer or after the formation and transfer processing at the same moment, the protecting layer (21) is separated from the support sheet (11) or the releasable layer to remain as the outermost layer of the transfer sheet. This layer serves to protect the transferred material (31) and the picture layer (22) from chemicals and friction. A protecting layer material used to form the protecting layer (21) is a mixture of resin composition providing cross-linking reaction and actinic-radiation-curing reaction and colloidal silica particles bearing free silanol groups on their surface.

The said resin composition is an actinic-radiation-curable resin composition comprising a polymer A having a (meta)acrylic equivalent of 100 to 300 g/eq, a hydroxyle value of 20 to 500, and a weight-average molecular weight of 5000 to 50000 and a polyfunctional isocyanate. Its details are described in Japanese patent Laid-Open No. 10-58895 bulletin. The actinic-radiation-curable resin composition comprising the polymer A and the polyfunctional isocyanate will be briefly described.

The (meta)acrylic equivalent of the polymer A may be 100 to 300 g/eq, preferably 150 to 300 g/eq, in terms of its hardenability at the time of actinic radiation. The hydroxyle value of the polymer A may be 20 to 500, preferably 100 to 300, in terms of its reactivity with the polyfunctional isocyanate used together. The weight-average molecular weight of the polymer A may be 5000 to 50000, preferably 8000 to 40000.

The process for the production of the polymer A is not restricted; therefore, methods heretofore known may be used. The methods include, for example,

(1) a method of introducing (meta)acryloyl groups to part of the side chain of polymer bearing hydroxyl groups;
(2) a method of reacting copolymer bearing carboxyl groups with α,β-unsaturated monomer bearing hydroxyl groups through a condensation reaction;
(3) a method of reacting copolymer bearing carboxyl groups with α,β-unsaturated monomer bearing epoxide groups through an addition reaction; and
(4) a method of reacting polymer bearing epoxide groups with α,β-unsaturated carboxylic acid.

Referring the method (4) as an example, a process for the production of polymer A will be described in detail. For example, polymer A to be used in the present invention can be provided by reacting polymer bearing glycidy groups with α,β-unsaturated carboxylic acid such as acrylic acid. Polymer bearing glycidy groups includes, for example, preferably glycidy (meta)acrylate homopolymer and co-polymer of glycidy (meta)acrylate with α,β-unsaturated monomer bearing no carboxly group. The α,β-unsaturated monomer bearing no carboxly group includes, for example, various (meta)acrylic acid ester, styrene, vinyl acetate, and acrylic nitrile.

The polyfunctional isocyanate used together with the polymer A is not restricted; therefore, various kinds of polyfunctional isocyanates heretofore known may be used. They include, for example, isophorone diisocyanate, xylyene diisocyanate, hydrogenerated xylyene diisocyanate, tolylene diisocyanate, diphenylmethane diisocyanate, 1,6-hexane diisocyanate, and trimeric structures of the diisocyanates described above, and prepolymers obtained by reacting multiple alcohol with the diisocyanates described above. For the proportion of the polymer A to the polyfunctional isocyanate, the proportion of the number of hydroxyle groups to that of isocyanate groups in the polymer A may be 1/0.01 to 1/1, preferably 1/0.05 to 1/0.8.

The colloidal silica particles have 1 to 50 (counts/nm²) of free silanol groups. When the amount of free silanol groups is in the range described above, such colloidal silica particles have desirable reactivity. The primary particle size of the colloidal silica particles is generally 1 to 200 nm, preferably 10 to 50 nm. When the primary particle size is in such a range, the burr inhibition is effective and the protecting film keep its transparency. Colloidal silica particles with the particle size of 10 to 20 nm are easily available at low cost.

Mixture fraction of the colloidal silica and the polymer A is colloidal silica/polymer A=0.2 to 1.0 (solid content ratio by weight). If the mixture fraction is lower than the above mixture fraction, the burr inhibition is less effective. On the other hand, if the mixture fraction is higher than the above mixture fraction, cracks are prone to be generated at the time of the transfer or of the formation and transfer processing at the same moment. The mixture fraction is colloidal silica particles/polymer A=0.4 to 1.0, preferably 0.8 to 1.0 (solid content ratio by weight), which results in further improved wear resistance of the protecting layer.

The materials used for the protecting layer (21) may contain, if necessary, components other than the polymer A, the polyfunctional isocyanate, and the colloidal silica particles. Such components include, for example, reactive dilute monomer, solvent, and colorant. The use of electron beam for actinic radiation requires no photopolymerization initiator for sufficient effect. However, the use of ultraviolet rays requires the addition of a photopolymerization initiator heretofore known.

The protecting layer materials contain silanol groups on the surface of the colloidal silica particles, unsaturated groups of ethylene moieties, and isocyanate groups. When the actinic-radiation-curable resin composition is heated, the hydroxyl groups, the silanol groups, and the isocyanate groups react, leading to cross-linkage of resin. When the actinic-radiation-curable resin composition is exposed to actinic radiation, the ethylene unsaturated groups of ethylene moieties are polymerized. That is to say, the protecting layer materials forming the protecting layer (21) are cross-linked both by heat and actinic radiation.

As methods of attaching the protecting layer (21), coating methods (such as a gravure coating method, a roll coating method, a comma coating method, and a lip coating method) and printing methods (such as a gravure printing method and a screen printing method) are available. In general, the thickness of the protecting layer (21) is 0.5 to 30 μm, preferably 2 to 15 μm. When the thickness is in this range, the wear resistance works well and the resistance to burr generation is further improved.

After the protecting layer described above is attached to the support sheet, the support sheet with the said protecting layer is heated, for example, at 150° C. for one minute, for cross-linkage reaction of the protecting layer.

### <Measurement of Temperature in the Release Temperature Range>

To approximate temperatures located in the release temperature range, the temperature of the break part (contoured part) left in the mold cavity immediately after the formation and transfer processing at the same moment was measured. FIG. 2 is a cross sectional view of the mold and the like showing the point where the temperature was measured. In FIG. 2, 51 is a mold A, 52 is a mold B, 53 is an injection nozzle, 54 is a molded article, 20 is a transfer layer, 55 is a transfer consecutive sheet, and 61 is an arrow showing the break part.

### <Results>

Table 1 shows the results of temperature measurement.

TABLE 1

| | Resin | Mold | Break part |
|---|---|---|---|
| Resin | temperature | temperature | temperature |
| PMMA | 250° C. | 50° C. | 81° C. |
| PMMA | 250° C. | 65° C. | 84° C. |
| PC | 285° C. | 60° C. | 98° C. |

Abbreviation:
PMMA: polymethylmethacrylate
PC: polycarbonate

The resin temperature is a temperature of the resin measured at the time of the injection of the molten resin into the mold. The break part temperature is a temperature measured immediately after the formation and transfer processing at the same moment. The mold temperature is a preset temperature of the mold temperature control unit. The mold temperature rose once, but then cooled down at a rapid speed, returning to the preset temperature because the mold is metallic, and so on. The molds, whether equipped with a cooling mechanism or not, show the same variation in temperature described above, that is to say, temporary rise and rapid return to the preset temperature.

Burr generation is a situation where when the transfer layer (transfer film) is released from the support sheet after the formation and transfer processing at the same moment or after the transfer, the transfer layer is sheared off or torn off at the break part. The determination of whether such situation occurred or not depends on the condition of film (viscosity) of the break part at that time. The results estimate that the median temperature at the released area is 81° C. to 98° C. and the temperature range is from approximately 70° C. to approximately 110° C.

It is also estimated that the transfer temperature range lies below 285° C. or 250° C. and that the median transfer temperature is approximately 200° C., considering the cooling down of the mold.

### <Viscosity Measurement>

A coating film comprising a Si heat cross-linking product was prepared by mixing an actinic-radiation-curable resin composition comprising a polymer A and a polyfunctional isocyanate with colloidal silica particles and heating the resultant product. Then the viscosity of the coating film prepared was measured, with the temperature being varied. As control, a coating film comprising a NonSi heat cross-linking product was prepared by heating an actinic-radiation-curable resin composition comprising a polymer A and a polyfunctional isocyanate. Then the viscosity of the coating film prepared was measured in the same way.

### (Measuring Instrument and Method)

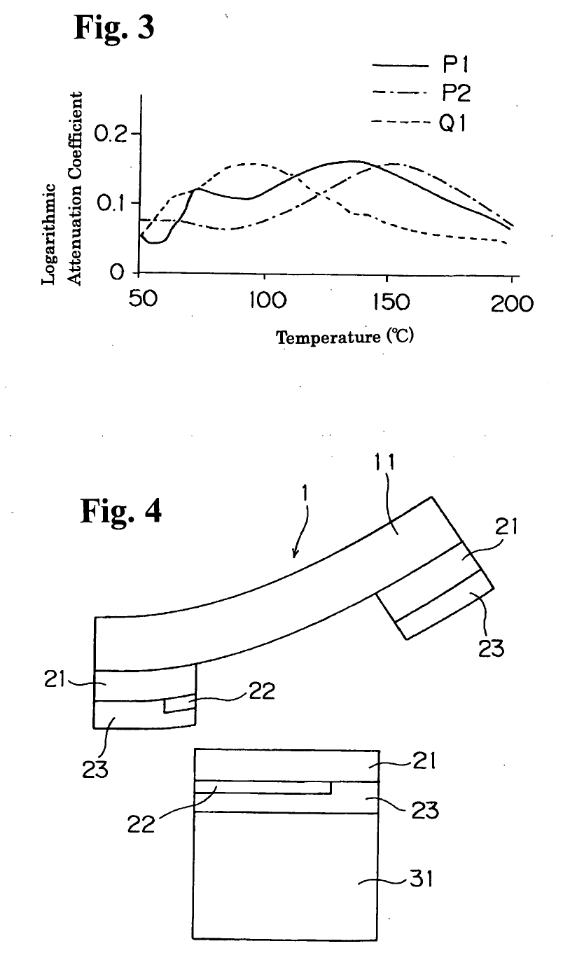

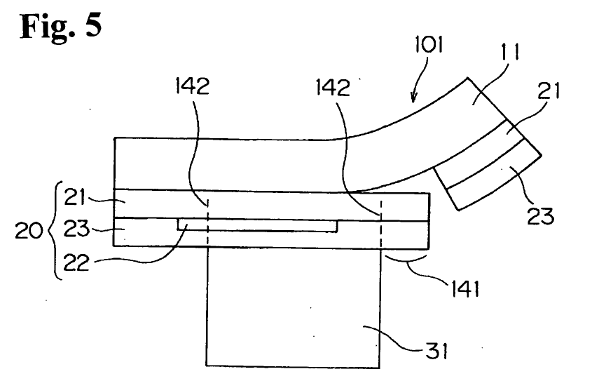

A Rigid-Body Pendulum Type Physical Properties Testing Instrument RPT-3000W (manufactured by A&D Company, Limited) was used for the measurement. The instrument measures viscosity properties dynamically by applying vibration to a pendulum so that the surface of a coated film comes to the fulcrum of the swing. The value of logarithmic attenuation coefficient means viscosity, in which the greater value means the higher viscosity. The measurement was carried out, with the rate of temperature increase of 12° C./min being kept. The relationship between logarithmic attenuation coefficient and temperature was graphed in FIG. 3. In the graph, the peaks of temperature represent a glass transfer temperature (Tg) of the coatingfilm.

### <Composition of Resin Composition and Method of Preparing Coating Film>

Each of the following three kinds of coating liquids was coated to a plate for measurement to have a thickness of 20 μm by using an applicator:
1. a coating liquid, wherein no colloidal silica particle was mixed;
2. a coating liquid, wherein 133 parts of colloidal silica particles (c) were mixed with the composition described below [colloidal silica/polymer A=0.4 (solid content ratio by weight)]; and
3. a coating liquid, wherein 267 parts of colloidal silica particles (c) were mixed with the composition described below [colloidal silica/polymer A=0.8 (solid content ratio by weight)]
   and then was heated at 150° C. for one minute:
   200 parts (solid content: 100 parts) of polymer A (a), 5 parts of polyfunctional isocyanate (b), and 5 parts of photo initiator (d).

The resulting Si heat cross-linking product of item 2 described above (solid content ratio by weight: 0.4) is P1, the resulting Si heat cross-linking product of item 3 described above (solid content ratio by weight: 0.8) is P2, and the resulting NonSi heat cross-linking product of item 1 described above is Q1.
Polymer A (a)
A polymer composed mostly of glycidylmetaacrylate, methylmetaacrylate, and azobisisobutyronitrile. Its major properties were:
   Acrylic equivalent weight: 270 g/eq
   Hydroxyl value: 204
   Weight-average molecular weight: 18,000
   Solid content: 50%
   Dispersion medium: ethyl acetate
Polyfunctional isocyanate (b): 1,6-hexanediisocyanate (CORONATE HX manufactured by Nippon Polyurethane Industry Co., LTD.)
Colloidal silica particles (c): ORGANO SILLICA SOL MEK-ST manufactured by Nissan Chemical Industries, LTD. (primary particle size: 10 to 20 nm, free silanol group: 1 to 50 (counts/nm2), solid content: 30%)
Photo initiator (d): IRGACURE 184 manufactured by Nippon Ciba-Geigy K.K.

### (Results)

FIG. 3 shows the measurement results.

In the temperature range from approximately 75° C. to approximately 110° C., the logarithmic attenuation coefficient of P1 and P2 was smaller (that is to say, lower viscosity value) than that of Q1. As shown in the temperature measurement results described above, the temperature range from approximately 75° C. to approximately 110° C. is within the release temperature range described above. Low viscosity value in this temperature range means that the resistance to burr generation is excellent. In the temperature range from approximately 75° C. to approximately 110° C., the logarithmic attenuation coefficient of P2 is smaller (that is to say, lower viscosity value) than that of P1. These results show that the higher the mixture fraction ratio of colloidal silica to polymer A is, the lower the viscosity value tends to be.

The three heat cross-linking products were listed in ascending order of the glass transfer temperature as follows: Q1, P1, and P2.

All of the logarithmic attenuation coefficients (that is to say, viscosity value) of P1, P2, and Q1 were almost the same near 200° C. From the temperature measurement results described above, the temperatures near 200° C. are estimated to be within the transfer temperature range. Q1 (control) is a protecting layer material which is fundamentally excellent in preventing cracks from being produced at the curved surface of the transferred material. Therefore, it has become evident that P1 and P2 are as excellent as Q1 in preventing cracks from being produced at the curved surface of the transferred material.

For the releasable support sheet (11), resin sheets such as polypropylele-based resin, polyethylene-based resin, polyamide-based resin, polyester-based resin, polyacryl-based resin, polyvinyl chloride-based resin, and the like, all of which are generally used for support sheets of transfer sheet, may be used.

If the transfer layer (20) can be neatly released from the support sheet (11), the transfer layer (20) may be formed directly on the support sheet (11). To improve releasability of the transfer layer (20) from the support sheet (11), a releasable layer may be formed on the whole surface before the establishment of the transfer layer (20) on the support sheet (11). When the support sheet (11) is released after the transfer or after the formation and transfer processing at the same moment, the releasable layer is released together with the support sheet (11) from the transfer layer (20). For materials for the releasable layer, melamine resin-based release agent, silicon resin-based release agent, fluorine resin-based release agent, cellulose derivative-based release agent, urea resin-based release agent, polyolefin resin-based release agent, paraffin-based release agent, and complex types of these release agents may be used. As methods of forming a releasable layer, coating methods (such as a gravure coating method, a roll coating method, a spray coating method, a lip coating method, and a comma coating method) and printing methods (such as a gravure printing method and a screen printing method) are available.

The picture layer (22) is formed on the protecting layer (21), normally as a printing layer. For materials for the printing layer, a polyvinyl-based resin, polyamide-based resin, polyester-based resin, polyacryl-based resin, polyurethane-based resin, polyvinyl acetal-based resin, polyester urethane-based resin, cellulosic ester-based resin, alkyd resin, and the like may be used as binder and inks containing pigments or dyes of appropriate color as coloring agent may be used. As method of forming the picture layer (22), commonly-used printing methods such as an offset printing method, a gravure printing method, and a screen printing method are available. In particular, an offset printing method and a gravure printing method are suitable for polychromatic printing and gradation expression. In the case of monochrome, coating methods such as a gravure coating method, a roll coating method, a comma coating method, and a lip coating method are available. The picture layer (22) may be formed on the whole surface or partly, depending on the picture to be expressed. Furthermore, the picture layer (22) may comprise a metal evaporated layer(s) or may be the combination of a printing layer(s) and a metal evaporated layer(s).

The adhesive layer (23) is a layer for sticking each of the layers described above to the surface of the transferred material (31). The adhesive layer (23) is formed on the desired part of the protecting layer (21) or the picture layer (22). That is to say, if the desired part covers the whole of the surface, the adhesive layer (23) is formed on the whole surface. If the desired part covers only part of the surface, the adhesive layer (23) is formed partly. As materials for the adhesive layer (23), thermosensitive or pressure-sensitive resin suitable for the material of the transferred material (31) may be used appropriately. For example, if the material of the transferred material (31) is polyacryl-based resin, a polyacryl-based resin may be used. And if the material of the transferred material (31) is polyphenyleneoxide polystyrene-based resin, polycarbonate-based resin, styrene copolymer-based resin or polystyrene-based blend resin, then polyacryl-based resin, polystyrene-based resin, polyamide-based resin, and the like having an affinity for these kinds of resin are available. Furthermore, if the material of the transferred material (31) is polypropylene-based resin, then chlorinated polyolefins resin, chlorinated ethylene vinyl acetate copolymer resin, cyclized rubber, and coumarone indene resin may be used. As methods of forming the adhesive layer (23), coating methods (such as a gravure coating method, a roll coating method, and a comma coating method) and printing methods (such as a gravure printing method and a screen coating) are available. However, if the protecting layer (21) and the picture layer (22) have sufficient adhesion to the transferred material (31), the adhesive layer (23) is not needed.

The composition of the transfer layer (20) is not restricted to the embodiments described above. For example, if a transfer sheet is used only for purpose of utilizing the basic design and transparency of the transferred material (31) and executing protective-surface processing, the protecting layer (21) and the adhesive layer (23) may be formed sequentially on the support sheet (11) as described above. This means that the picture layer (22) may be deleted from the transfer layer (20).

A process for the production of the molded articles using the transfer sheet (1) having the layer composition described above will be described. First, the transfer sheet (1) is placed on the transferred material (31), with the side of the adhesive layer (23) being downside. Next, heat and/or pressure are applied from the side of the support sheet (11) of the transfer sheet (1) via a heat-resistant rubber-like elastic body by using a transcriber, such as a roll transcriber and an up-down transcriber, which is equipped with silicon rubber. In this case, the adhesive layer (23) adheres to the surface of the transferred material (31). The support sheet (11) is released after it cooled down. This leads to peel-off on the boundary surface between the support sheet (11) and the protecting layer (21). If the releasable layer is arranged on the support sheet (11), the release of the support sheet (11) leads to peel-off on the boundary surface between the releasable layer and the protecting layer (21). FIG. 4 shows the scene of the support sheet (11) being released after the transfer of the transfer layer (20) to the transferred material (31).

Finally, actinic radiation is irradiated, which leads to complete cross-linkage and curing of the protecting layer (21) transferred to the transferred material (31). As actinic radiation, electron beam, ultraviolet ray, and γ-ray, for example, may be used. The irradiation conditions are decided according to an actinic-radiation-curable resin composition to be used.

Materials of the transferred material (31), which are not restricted, include, for example, resin articles, wooden handicrafts, and the combination of them. These may be transparent, translucent or opaque. The transferred material (31) may be colored or not colored. Resins include, for example, polystyrene-based resin, polyolefin-based resin, ABS resin, AS resin, and AN resin, which all are commonly available. Furthermore, general-purpose engineering resins (such as polyphenyleneoxide polystyrene-based resin, polycarbonate-based resin, polyacetal-based resin, acrylate resin, polycarbonate modified polyphenylene ether resin, polyethylene terephthalate resin, polybutylene terephthalate resin, ultrahigh molecular weight polyethylene resin) and super engineering resins (such as polysulfone resin, polyphenylene sulfide-based resin, polyphenylene oxide-based resin, polyacrylate resin, polyetherimide resin, polyimide resin, liquid crystalline polyester resin, and polyallyl-based heat-resistant resin) may be also used. Furthermore, composite resin to which reinforcing agents such as glass fiber and inorganic filler are added may be also used.

Next described will be the method of applying a protecting layer and the like having wear resistance and chemical resistance to the surface of resin molded articles provided by utilizing the formation and transfer processing at the same moment by the injection formation, in which method a transfer sheet is used. First, the transfer sheet (1) is fed into the mold for molding consisting of the mold A and the mold B, in which case the transfer layer (20) is inward. On this occasion, some transfer sheets may be fed one by one or the needed part of the long transfer sheet (1) may be fed intermittently. In the case of the long transfer sheet (1) being used, it is recommended that the register of the picture layer (22) of the transfer sheet (1) should correspond with that of the mold for molding by using a feeder having a positioning mechanism. Then, after the mold for molding is closed, melting resin is injected into the mold through the gate of the mold B. As the transferred material (31) is molded, the transfer sheet (1) is simultaneously attached to its surface. After the resin article cooled down, the mold for molding is opened to eject it. After the support sheet (11) is released, actinic radiation is irradiated, which leads to complete cross-linkage and curing of the protecting layer (21).

### Example 1

### Taber Abrasion Evaluation Test

The transfer sheets were prepared, for which the concentration of colloidal silica particles in the protecting layer material was varied (four sorts). Then, the molded articles, to which each of the transfer sheets was transferred, were manufactured. After that, the taber abrasion evaluation test was carried out for the transfer sheets. Visual burr evaluation test was also carried out in parallel.

### (Measuring Instrument and Method)

A Taber type abrasion tester (manufactured by Tester Sangyo Co., Limited) was used.

The test conditions are as follow:
Test method: in accordance with ISO 9352 and JIS K7204
Abrasive wheel: CS-10
Load: 500 g

### (Manufacturing Molded Article)

The material for the formation and transfer processing at the same moment for which a protecting layer coated film, a primer layer, a picture ink layer, and an adhesive layer were sequentially formed on the release-processed support sheet, was manufactured. A plate-shaped molded article of 100 mm×100 mm was obtained by the formation and transfer processing at the same moment by using polymethylmethacrylate molded resin. This molded article was used for the Taber abrasion test. In the test, the number of times the abrasive wheel rotated until the picture was peeled off and the base became exposed was counted.

### (Composition of Resin Composition and Method of Preparing Coated Film)

The following four kinds of coating liquids were diluted with methyl ethyl ketone to form 30% of solid content and were bar-coated with #18 bar:
a coating liquid, wherein no colloidal silica particle was mixed;
a coating liquid, wherein 66 parts of colloidal silica particles (c) were mixed with the composition mentioned below [colloidal silica/polymer A=0.2 (solid content ratio by weight)];
a coating liquid, wherein 133 parts of colloidal silica particles (c) were mixed with the composition described below [colloidal silica/polymer A=0.4 (solid content ratio by weight)]
a coating liquid, wherein 267 parts of colloidal silica particles (c) were mixed with the composition described below [colloidal silica/polymer A=0.8 (solid content ratio by weight)]
   and then were heated at 150° C. for 30 seconds:
   200 parts (solid content: 100 parts) of polymer A (a), 5 parts of polyfunctional isocyanate (b), and 5 parts of photo initiator (d).

After that, a primer layer, a picture ink layer, and an adhesive layer were sequentially formed by using a bar-coater.

The polymer A (a), the polyfunctional isocyanate (b), the colloidal silica particles (c) and the photo initiator (d) used in the test were the same as materials used in the viscosity measurement described above. After the formation and transfer processing at the same moment, the support sheet was released and UV ray was irradiated (irradiance level: 920 mJ).

The TABLE 2 shows the results of the Taber abrasion evaluation test

TABLE 2

| Evaluation No. | 1 | 2 | 3 | 11 |
|---|---|---|---|---|
| Protecting layer material (Note 1) | Silica/ | Silica/ | Silica/ | Polymer |
| | polymer | polymer | polymer | only |
| | A = 0.2 | A = 0.4 | A = 0.8 | |
| Thickness of protecting layer | 5.2 | 5 | 4.9 | 5.1 |
| (μm) | | | | |
| The number of times the | 4490 times | 6010 times | 6830 times | 2920 times |
| abrasive wheel rotated until | | | | |
| the picture was peeled off and | | | | |
| the base became exposed | | | | |
| Burr (Note 2) | Δ | ◯ | ◯ | X |

(Note 1):
Colloidal silica is abbreviated as Silica.
(Note 2):
Evaluation of burr: X: many burrs Δ: rather many burrs ◯: few burrs

### (Results)

The transfer sheet for which colloidal silica particles were added to the protecting layer material was excellent in resistance to burr generation. The molded article for which such transfer sheet was used had more number of times the abrasive wheel rotated until the base became exposed. This means that the improved wear resistance of the molded article was observed.

1.-6. (canceled)

7. A process for the production of a transfer sheet comprising the following operations:
a) an operation of manufacturing a protecting layer material by mixing an actinic-radiation-curable resin composition comprising a polymer A having a (meta)acrylic equivalent of 100 to 300 g/eq, a hydroxyle value of 20 to 500, and a weight-average molecular weight of 5000 to 50000 and a polyfunctional isocyanate with colloidal silica particles bearing free silanol groups on their surface;
b) an operation of forming a protecting layer in uncross-linked state on a separable support sheet by attaching the said protecting layer material; and
c) an operation of forming a protecting layer by producing a product of heat cross-linking among the polymer A, the polyfunctional isocyanate, and the colloidal silica particles by heating the said protecting layer in uncross-linked state.

8. A process for the production of a transfer sheet of claim 7, wherein the particle size of the said colloidal silica particles is 1 to 200 nm.

9. A process for the production of a transfer sheet of claim 7, wherein the ratio by weight of the solid content of the colloidal silica particle/polymer A of the said protecting layer material is 0.2 to 1.0.

10. A process for the production of a transfer sheet of claim 8, wherein the ratio by weight of the solid content of the colloidal silica particle/polymer A of the said protecting layer material is 0.2 to 1.0.

11. A transfer sheet having a protecting layer arranged on a releasable support sheet, wherein a protecting layer contained in the said transfer layer is a protecting layer containing a product of heat cross-linking among the polymer A, the polyfunctional isocyanate, and the colloidal silica particles formed by heating the protecting layer in an uncross-linked state made of a protecting layer material prepared by mixing an actinic-radiation-curable resin composition comprising a polymer A having a (meta)acrylic equivalent of 100 to 300 g/eq, a hydroxyl value of 20 to 500, and a weight-average molecular weight of 5000 to 50000 and a polyfunctional isocyanate with colloidal silica bearing free silanol groups on the surface.

12. A transfer sheet according to claim 11, wherein the primary particle size of the said colloidal silica particles is 1 to 200 nm.

13. A transfer sheet of claim 11, wherein the ratio by weight of the solid content of colloidal silica particle/polymer A of the said protecting layer material is 0.2 to 1.0.

14. A transfer sheet of claim 12, wherein the ratio by weight of the solid content of colloidal silica particle/polymer A of the said protecting layer material is 0.2 to 1.0.
